(19) United States
(12) Patent Application Publication
(10) Pub. No.: US 2012/0126070 A1
(43) Pub. Date: May 24, 2012

(54) Plate for Protecting a Cable Along a Stud

(75) Inventors: Daniel Lalancette, St-Jean-sur-Richelieu (CA); Ioan-Liviu Lupsa, Dollard-des-Ormeaux (CA); Serge Michaud, Brossard (CA); Pierre Aubin, St-Jean-sur-Richelieu (CA)

(73) Assignee: Thomas & Betts International, Inc.

(21) Appl. No.: 12/953,192

(22) Filed: Nov. 23, 2010

(51) Int. Cl. F16L 3/02; F16L 3/24

(52) U.S. Cl. 248/71; 248/49

(57) ABSTRACT

A plate for protecting a cable along a stud is provided that prevents damage to the cable when screws or nails are inserted through drywall and into the stud. The plate comprises a channel for receiving the cable and a flange which is attached to the channel for mounting the plate. A retaining tab is used to retain the cable within the channel. The channel is shaped such that a series of plates can be joined together in partial overlapping arrangement.

### FIELD OF THE INVENTION

In general, the present invention relates to a plate for protecting a cable along a stud. More particularly, the present invention relates to a flange for mounting the plate, a channel for receiving the cable, a channel shape that allows for overlapping of multiple plates, and a retaining tab for purposes of retaining a cable within the channel of the plate.

### SUMMARY OF THE INVENTION

The present invention eliminates the above described disadvantages by providing a plate for protecting a cable along a stud. The plate for protecting the cable includes a channel for receiving the cable and a flange which is attached to the channel for mounting the plate. The flange may contain integral nails for attachment of the plate to the stud, or it may contain at least one aperture for attachment of the plate to the stud by means of screws or nails. The plate for protecting the cable may also include a retaining tab for purposes of retaining the cable within the channel. The plate may be formed of a high-strength metal or non-metallic material to protect the cable from being damaged. To allow for overlapping of multiple plates, the channel shape is such that it allows for a series of plates to be joined together in partial overlapping arrangement. The channel may also have one or more flanges on the outside of the channel to prevent overlapping plates from sliding more than a desired distance over one another.

### BRIEF DESCRIPTION OF THE DRAWINGS

FIG. 1 is a front perspective view of a plate for protecting a cable along a stud of the present invention.

FIG. 2 is a rear perspective view of a plate for protecting a cable along a stud of the present invention.

FIG. 3 is a front perspective view of a single plate protecting a cable along a stud and of overlapping plates protecting a cable along multiple studs of the present invention.

FIG. 4 is a front perspective view of a plate for protecting a cable along a stud of the present invention.

FIG. 5 is a rear perspective view of a plate for protecting a cable along a stud of the present invention.

FIG. 6 is a front perspective view of a single plate protecting a cable along a stud and of overlapping plates protecting a cable along multiple studs of the present invention.

FIG. 7 is a front perspective view of a plate for protecting a cable along a stud of the present invention.

FIG. 8 is a rear perspective view of a plate for protecting a cable along a stud of the present invention.

FIG. 9 is a front perspective view of a single plate protecting a cable along a stud and of overlapping plates protecting a cable along multiple studs of the present invention.

### DETAILED DESCRIPTION OF THE PREFERRED EMBODIMENT(S)

The above and other features, aspects and advantages of the present invention will now be discussed in the following detailed description of preferred embodiments and appended claims, which are to be considered in conjunction with the accompanying drawings in which identical reference characters designate like elements throughout the views.

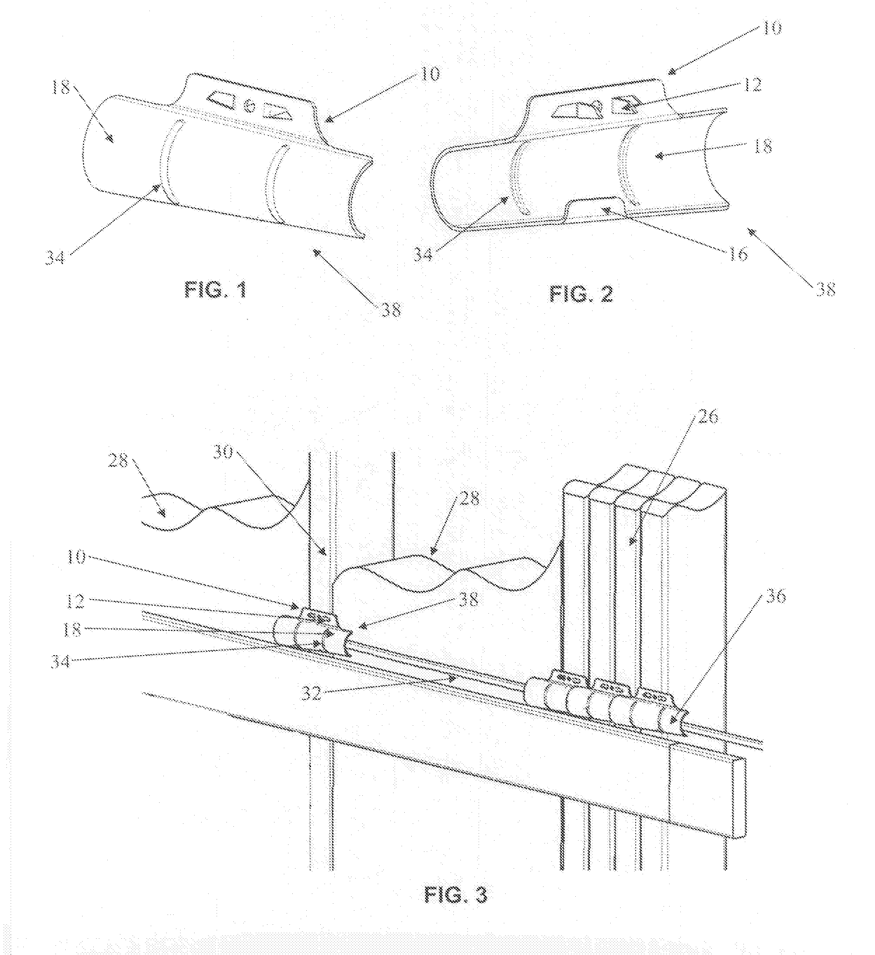

Shown in FIG. 1 is a front perspective view of the present invention, which is a plate 38 for protecting a cable along a stud. FIG. 1 shows the plate 38 consisting of a conical channel 18 for receiving the cable, a flange 10 which is attached to the conical channel 18 for mounting the plate 38, and strengthening ribs 34 which reinforce the plate 38 and allow for thinner material to be used than if the strengthening ribs 34 were not present, while simultaneously providing protection for the cable when housed in the conical channel 18. FIG. 2 shows a rear perspective view of the plate 38. In FIG. 2, integral nails 12 are shown which are contained within the flange 10 for attachment of the plate 38 to the stud. Also shown in FIG. 2 is a retaining tab 16 that is attached to the conical channel 18, which allows the cable to be retained within the conical channel 18.

FIG. 3 illustrates several overlapping plates 36 which are protecting a cable 32 which has been installed over insulation 28 and studs. The overlapping plates 36 may be mounted to a single stud 30 or multiple studs 26 by means of the flange 10 which contains the integral nails 12. These overlapping plates 36 have a channel that is shaped such that it allows for a series of plates to be joined together in partial overlapping arrangement. In FIG. 3 the overlapping plates 36 consist of the conical channel 18 shape. However, the channel shape may also be stepped cylindrical, angled cylindrical or any other channel shape which allows for overlapping of multiple plates. Regardless of channel shape, the plate 38 for protecting the cable 32 should be formed of a high-strength material, be it metallic or non-metallic, to protect the cable 32 from being damaged.

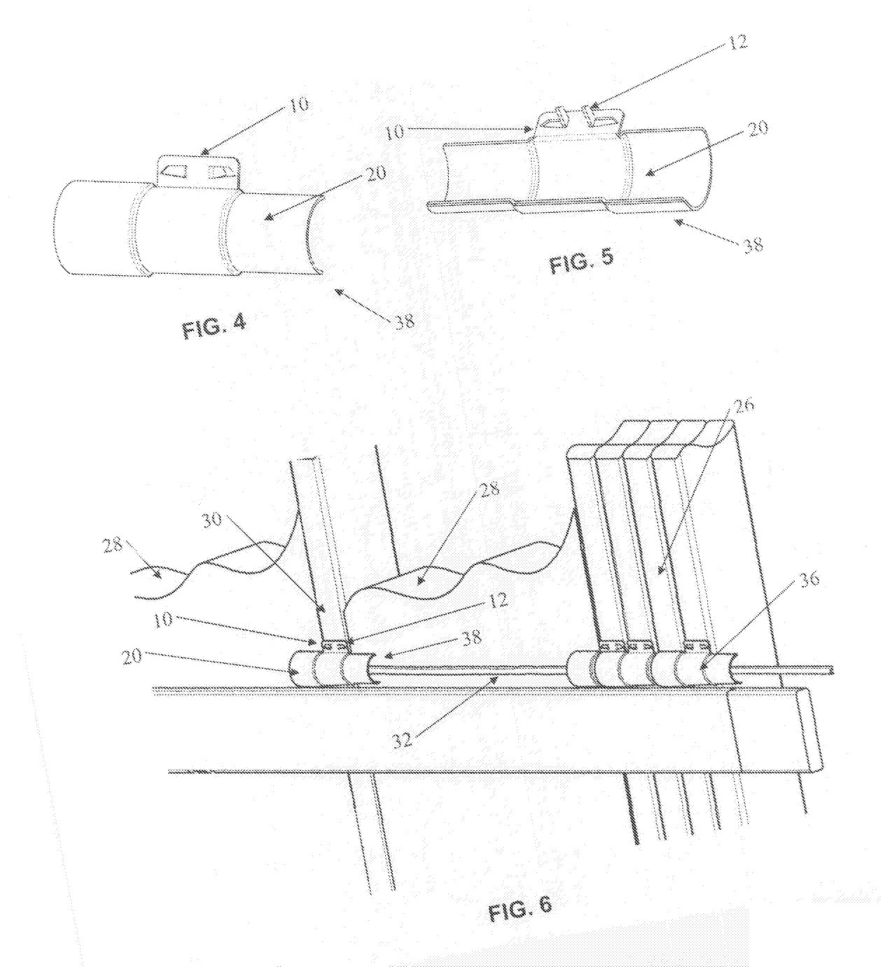

Shown in FIG. 4 is a front perspective view of the plate 38 which consists of a stepped cylindrical channel 20. FIG. 5 again shows the stepped cylindrical channel 20 for receiving the cable, along with the flange 10 for mounting the plate 38 and the integral nails 12 for attachment of the plate 38 to the stud. Though not shown in FIG. 5 as part of the stepped cylindrical channel 20, the plate 38 could also contain the retaining tab 16, such as shown in FIG. 2, for purposes of retaining the cable within the channel.

FIG. 6 shows the same arrangement of overlapping plates 36 protecting the cable 32 as shown in FIG. 3. The channel shape shown is the stepped cylindrical channel 20, but the channel may be any shape which allows for overlapping of multiple plates for attachment to multiple studs 26 or for attachment of the plate 38 to the single stud 30 by means of the integral nails 12 which are contained in the flange 10.

In FIG. 7, a front perspective view of the plate 38 is shown which consists of an angled cylindrical channel 22. Also shown in FIG. 7 is the flange 10 which contains apertures 24 for attachment of the plate 38 to the stud by means of screws or nails. Two apertures 24 are shown in FIG. 7, however, it is understood that the flange 10 could contain at least one aperture for means of attachment with screws or nails. It is also understood that regardless of the channel shape used for the plate 38, the flange 10 could contain either the integral nails 12 such as shown in FIGS. 2 and 5 or at least one aperture for attachment by means of screws or nails, such as shown by the apertures 24 in FIGS. 7-9. FIG. 7 also shows the angled cylindrical channel 22 having flanges 14 on the outside of the channel to prevent overlapping plates 36, such as shown in FIGS. 3, 6 and 9 from sliding more than a desired distance over one another.

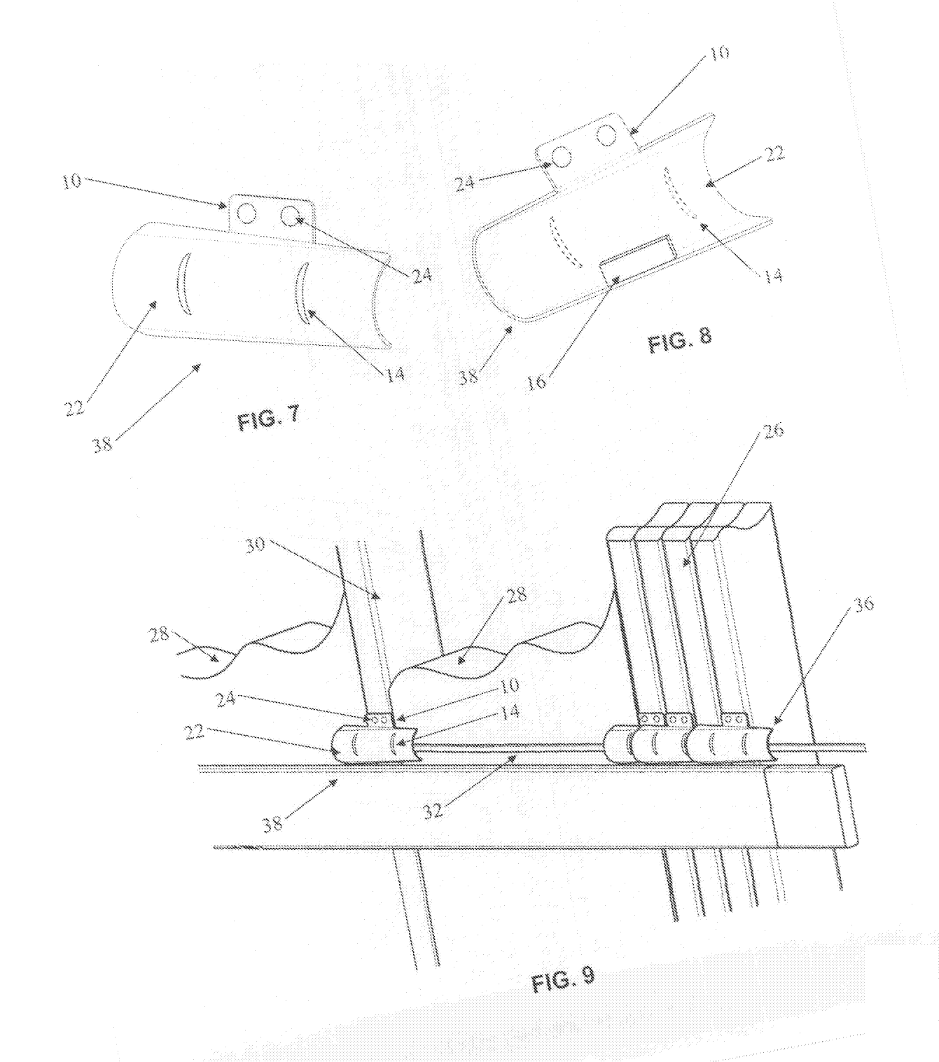

FIG. 8 again shows the plate 38 that consists of the angled cylindrical channel 22, but from a rear perspective view. Shown in FIG. 8 is the retaining tab 16, such as shown in FIG. 2, which allows the cable to be retained within the angled cylindrical channel 22. Though the retaining tab 16 is only shown in FIGS. 2 and 8, it is understood that regardless of the channel shape used for the plate 38, the retaining tab 16 could be used.

FIG. 9 shows the arrangement of overlapping plates 36, such as shown in FIGS. 3 and 6, which are protecting the cable 32. Shown again in FIG. 9 are the flanges 14 that prevent the overlapping plates 36 from sliding more than the desired distance over one another.

Although the invention has been described in detail above, it is expressly understood that it will be apparent to persons skilled in the relevant art that the invention may be modified without departing from the spirit of the invention. Various changes of form, design, or arrangement may be made to the invention without departing from the spirit and scope of the invention. Therefore, the above mentioned description is to be considered exemplary, rather than limiting, and the true scope of the invention is that defined in the following claims.

What is claimed is:

1. A plate for protecting a cable along a stud comprising:
a channel for receiving the cable;
a flange which is attached to the channel for mounting the plate; and
wherein the channel is shaped such that it allows for a series of plates to be joined together in partial overlapping arrangement.

2. The plate for protecting the cable of claim 1 wherein a retaining tab is attached to the channel for purposes of retaining the cable within the channel.

3. The plate for protecting the cable of claim 1 wherein the flange contains integral nails for attachment of the plate to the stud.

4. The plate for protecting the cable of claim 1 wherein the flange contains at least one aperture for attachment of the plate to the stud by means of screws or nails.

5. The plate for protecting the cable of claim 1 wherein the plate is formed of a high-strength material to protect the cable from being damaged.

6. The plate for protecting the cable of claim 1 wherein the plate is reinforced with strengthening ribs that allow for thinner material to be used while still protecting the cable from being damaged.

7. The plate for protecting the cable of claim 1 wherein the channel shape is conical, stepped cylindrical, or angled cylindrical, which allows for overlapping of multiple plates.

8. The plate for protecting the cable of claim 1 wherein the outside of the channel has one or more flanges to prevent overlapping plates from sliding more than a desired distance over one another.

9. A plate for protecting a cable along a stud comprising:
a channel for receiving a cable;
a flange which is attached to the channel for mounting the plate; and
a retaining tab which is attached to the channel for purposes of retaining the cable within the channel.

10. The plate for protecting the cable of claim 9 wherein the flange contains integral nails for attachment of the plate to the stud.

11. The plate for protecting the cable of claim 9 wherein the flange contains at least one aperture for attachment of the plate to the stud by means of screws or nails.

12. The plate for protecting the cable of claim 9 wherein the channel shape is conical, stepped cylindrical, or angled cylindrical, which allows for overlapping of multiple plates.

13. The plate for protecting the cable of claim 9 wherein the plate is formed of a high-strength metal to protect the cable from being damaged.

14. The plate for protecting the cable of claim 9 wherein the plate is formed of a high-strength, non-metallic material to protect the cable from being damaged.

15. A plate for protecting a cable along a stud comprising:
a channel for receiving a cable;
a flange which is attached to the channel for mounting the plate;
a retaining tab which is attached to the channel for purposes of retaining the cable within the channel; and
wherein the channel shape is conical, stepped cylindrical, or angled cylindrical, which allows for overlapping of multiple plates.

16. The plate for protecting the cable of claim 15 wherein the flange contains integral nails for attachment of the plate to the stud.

17. The plate for protecting the cable of claim 15 wherein the flange contains at least one aperture for attachment of the plate to the stud by means of screws or nails.

18. The plate for protecting the cable of claim 15 wherein the outside of the channel has one or more flanges to prevent overlapping plates from sliding more than a desired distance over one another.

19. The plate for protecting the cable of claim 15 wherein the plate is formed of a high-strength metal to protect the cable from being damaged.

20. The plate for protecting the cable of claim 15 wherein the plate is formed of a high-strength, non-metallic material to protect the cable from being damaged.
